(19) United States
(12) Patent Application Publication
(10) Pub. No.: US 2021/0204634 A1
(43) Pub. Date: Jul. 8, 2021

(54) FOOT SWITCH AND RELATED METHODS

(71) Applicant: DHUPAR INNOVATIONS, LLC, Windsor, CO (US)

(72) Inventor: Scott DHUPAR, Windsor, CO (US)

(21) Appl. No.: 17/059,527

(22) PCT Filed: May 29, 2019
(86) PCT No.: PCT/US2019/034321

§ 371 Date: Nov. 30, 2020

Related U.S. Application Data
(60) Provisional application No. 62/677,739, filed on May 30, 2018.

(51) Int. Cl. A43B 3/00

(52) U.S. Cl. CPC A43B 3/0005; H01H 3/14

(57) ABSTRACT

A foot switch system has an actuating button and a communication mechanism responsive to a pressure on the actuating button, the communication mechanism configured to emit a wireless signal in response to the pressure on the actuating button. The system further has an attachment mechanism to removably attach the actuating button and communication mechanism to a user's first shoe. The communication mechanism is configured to control a power output of a medical device.

### CROSS-REFERENCE TO RELATED APPLICATIONS

This application claims priority to International PCT Application No. PCT/US2019/034321 filed on May 29, 2019 and entitled “Foot Switch and Related Methods;” this application claims priority to U.S. Provisional Application No. 62/677,739 filed on May 30, 2018 and entitled “Foot Switch and Related Methods,” the entire disclosure of which is incorporated by reference for all proper purposes.

### FIELD OF INVENTION

The present invention is generally related to foot pedals and foot switches that activate tools, apparatuses, and instruments in various fields of human endeavor. More particularly, this invention may be useful in a medical application for use in the operating room.

### BACKGROUND OF THE INVENTION

There are many fields of human endeavor that use foot switches (also known as foot pedals). Foot switches can be used to turn electrical equipment on and off with the foot, freeing the hands to perform other operations or providing ergonomic improvement to a workstation. Foot switches are used in medical, industrial, commercial, and electronic applications.

Many surgical procedures require the use of multiple surgical tools. Some of these tools are simple, non-powered devices (such as scalpels, scrapers, and tying instruments) while others are complex, power-source driven tools (such as burrs, saws, and electrocautery devices). These power tools are supplied by various electrical or pneumatic sources. Use of such power tools requires the surgeon using the tool to actuate the tool as necessary during the surgical procedure. However, the surgeon's hands are often not available for such tasks. The foot switch is designed to be operated by the surgeon's foot. A foot switch (or foot pedal) can be used to turn on and off the power to the tool desired by the surgeon. Typically, the surgeon depresses the foot switch to supply power to the tool and releases the foot switch to discontinue supply of power to the tool. Such a foot switch would be placed on the operating room floor underneath the patient table immediately in front of the surgeon.

Foot switches are typically not fixed in any particular location on the floor and are free to move around on the floor. During the course of an operation, with the natural shifting of the surgeon's feet, the user will inadvertently kick the foot switches so that the pedals move around and out of reach of the surgeon. This is common during surgery. When this occurs, the surgeon may have to blindly search around with the user's foot to find the foot switch, ask an assistant for help, or look down at the floor to determine the location of the foot switch. Each of these methods to locate the foot switch are not ideal for their own reasons. First, searching around with the surgeon's foot is frustrating to the surgeon, distracts the surgeon from the procedure at hand, and may lead to depression of the wrong foot switch thereby actuating the wrong tool. Secondly, employing the help of an assistant takes that assistant away from other important activities that the user may be performing. Finally, requiring aversion of the surgeon's vision from the surgical field to find the foot switch is not efficient for the surgeon because it takes focus away from the operative field and that may lead to inadvertent missteps during surgery. All of these methods to relocate the foot switch cause an interruption in the “flow of the operation.”

Moreover, it is common for a surgeon to use more than one tool that requires a foot switch. Having a plurality of foot switches on the floor results in alternating from one pedal to another and entanglement of their respective power cords. The location of the specific foot switch that activates a specific tool can become confusing to the surgeon, particularly while trying to focus on the procedure at hand. As stated earlier, the surgeon needs to look down at the different foot switches to avoid stepping on the wrong foot switch and, consequently, actuating the wrong tool.

It is also common during surgical procedures for the surgeon to alternate between the two sides of the table. However, traditional surgical power tools that are operable by foot switches have only one pedal. Therefore, when the surgeon switches from one side of the operating room table to the other side, it is necessary to move the pedals from one side to the other. This can happen several times during the course of a single operation. This requires help from an assistant who must interrupt other valuable work that the surgeon was performing.

Another common problem with foot switches has to do with the use of step stools. It is common during the course of certain procedures for the operating room table to be elevated so that the surgeon can employ the assistance of imaging modalities such as fluoroscopy or navigation. When the bed is elevated, the surgeon (and assistants) will have to stand on step stool(s) so that they can continue to perform the operation. The step stool(s) have limited surface area and it is difficult for the surgeon to stand on the step stool(s) with either one or a plurality of foot switches also on the step stool(s). Also, it is not uncommon for the foot switches to get knocked off the step stool(s) by the natural shifting of the surgeon's feet. This situation requires replacement of the foot switches by an assistant onto the step stool(s) thereby restarting the frustrating cycle.

There therefore remains a need for a novel foot switch that addresses the above-stated problems and/or provides other new and innovative features.

### BRIEF SUMMARY OF THE DISCLOSURE

An exemplary foot switch system has an actuating button and a communication mechanism responsive to a pressure on the actuating button, the communication mechanism configured to emit a wireless signal in response to the pressure on the actuating button. The system has an attachment mechanism to removably attach the actuating button and communication mechanism to a user's first shoe. The communication mechanism is configured to control a power output of a medical device.

An exemplary method includes providing a foot switch system, the foot switch system having an actuating button and a communication mechanism responsive to a pressure on the actuating button, the communication mechanism configured to emit a wireless signal in response to the pressure on the actuating button, and an attachment mechanism for removably attaching the communication mechanism and the actuating button to a user's first shoe, wherein the communication mechanism is configured to control a power output of a medical device. The method includes applying a pressure on the actuating button to cause the communication mechanism to emit a wireless signal in response to the pressure on the actuating button.

### BRIEF DESCRIPTION OF THE DRAWINGS

FIG. 1 is a perspective view of an exemplary foot switch in use on a shoe;

FIG. 2 is a perspective view of the foot switch in FIG. 1;

FIG. 3 is a top view of an exemplary foot switch system having a pair of shoes;

FIG. 4 is a top view of a first shoe and a bottom view of a second shoe in an exemplary foot switch system having a pair of shoes;

FIG. 5 is a front view of the second shoe in the system in FIG. 4; and

FIG. 6 is a flowchart of an exemplary method.

### DETAILED DESCRIPTION

A device capable of attaching an actuator, which may be wireless, to a user's shoe is disclosed. This device may be used to turn on and off power tools and electronic equipment that are traditionally activated using foot switches. The invention may be a multi-component re-attachable band of fabric, or other material, designed to securely attach an actuating button to the user's shoe or foot.

The actuator described herein may allow the user to efficiently and rapidly actuate devices that are traditionally activated using a foot switch. This disclosure describes a reversible shoe attachment mechanism with an actuating button, which may be positioned at the toe of the user's shoe. The user may push the actuating button by pointing the user's toe down on the floor and applying pressure to the toe of the shoe. This method of depressing the actuating button will avoid the need for the user to look down at a traditional foot switch in order to position the user's foot so as to turn on the desired tool. Also, the device will alleviate many of the deficiencies present with the current style of foot switch.

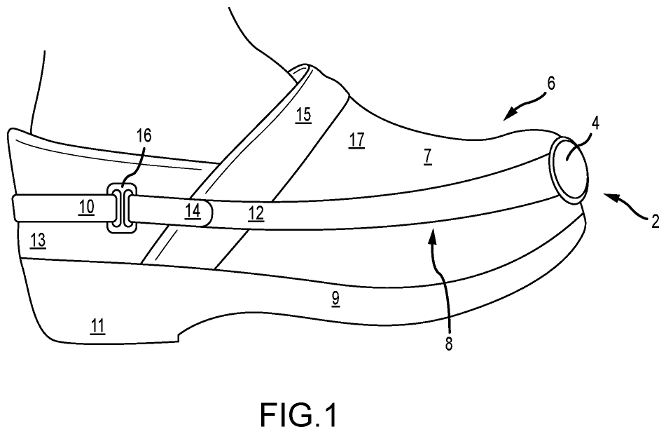

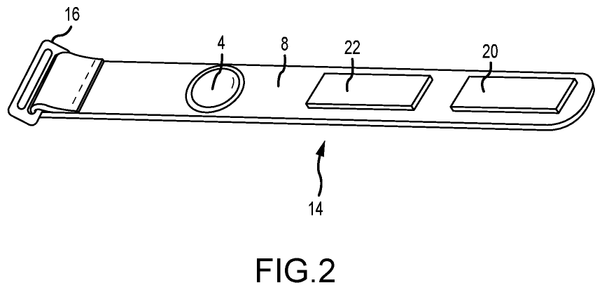

As illustrated in FIGS. 1 and 2, a foot switch 2 may include a wireless actuator 4 for a power tool or electronic device that is reversibly attached to the shoe of the user. Having the actuator attached to the shoe of the user may allow the user to activate the desired tool in a manner that is more convenient, more efficient, and more practical than is the case presently. In one some embodiments, an actuating button is located at the toe of the shoe so as to allow the user to slightly flex a knee, and/or plantar-flex the user's foot (i.e., point the user's toe) and apply gentle pressure on the actuating button (at the toe of the shoe) in order to turn on the desired power tool or electronic instrument (e.g., electrocautery). The user would assume this toe pointed position only when use of the power tool is needed and would assume a standard stance for the majority of the procedure. The simple and rapid positioning of the foot will employ muscle memory and will allow the user to save time and frustration over “blindly stepping around” in search of the desired foot switch or looking down at the floor to find the foot switch. The actuating button can be binary in that once pressure is removed from the actuating button, the power tool will automatically turn off. This binary design is common for existing foot switches. This simple and efficient method to actuate an instrument will save the user much time and avoid the frustration that is caused by having to repeatedly locate a mobile foot switch.

Generally, in use, when the user is at a table (such as in surgery), the user will commonly have the user's abdomen against the table and have both hands and forearms in stabilized positions while working. Having multiple points of stabilization such as this provides significant balance to the user and allows the user to easily balance on one leg and point the user's contralateral foot to actuate the power tool or electronic device. This stance is only occasionally required and most the time would be spent with both feet flat on the floor. Loss of balance or single leg fatigue is not a concern for the majority of uses or for the majority of users.

Because the actuating button is always located at the toe of the user's shoe, the user will not have to blindly search for a mobile foot switch by stepping around with the user's foot or ask for assistance in locating or moving the foot switch to a desired location. The user will not have to avert focus from the task at hand to locate the foot switch or to position the user's foot appropriately to activate the power tool or electronic device. The user will not inadvertently activate the wrong tool by blindly searching with the user's foot and locating the incorrect foot switch when more than one foot switch is being used for the same procedure. The user will not be frustrated by an interruption to the “flow of the procedure.” Multiple foot switches will not lead to entanglement of cords. The user will not have to ask for the foot switch to be re-located to the opposite side of the table when the user needs to alternate sides. Finally, the user will not be in danger of kicking a foot switch off a step stool when naturally shifting the user's feet.

Other inconveniences that will be avoided with use of the Shoe Pedal or foot switch are that there will no longer be the need for bulky foot pedals cluttering the operating room floor. This will reduce the risk of tripping over foot pedals or associated wires on the operating room floor. Because the Shoe Pedal is predictably located at the tip of the user's shoe, the actuating button can be fairly small relative to standard foot switches which need to be easy to find on the floor. The small actuating button may be sized and positioned in a way so that it is not accidentally deployed or damaged.

At least two Shoe Pedals or foot switches may be used by the same user (assuming the user is bipedal). This would allow the user to always know the location of actuating buttons for at least two devices. For example, in Orthopedic Surgery, it is common for the surgeon to use a bipolar electrocautery device and a high-speed burr. The actuators for these two devices could be attached to each of the surgeon's shoes. If a third foot switch activated device is needed for the operation, then a traditional foot switch could be used for that device while employing Shoe Pedals to activate the first two devices.

The foot switch 2 may have useful application in all fields of human endeavor in which foot switches are used. Some embodiments are described below as the relate to use in the operating room.

There is shown in the drawings (FIG. 1 and FIG. 2), and will be described in detail, an embodiment of the invention. There should be an understanding by those skilled in the art that the present disclosure is to be considered as an exemplification of the principles of the invention and is not intended to limit the broad aspect of the invention to embodiments herein illustrated.

As illustrated, a wireless foot switch 2 may be removably attached to a user's shoe or foot). The foot switch, which may be referenced interchangeably as a shoe pedal 2 may includes a wireless actuating button 4 that reversibly attaches to the user's foot via a shoe 6 and/or a re-attachable strap 8. The actuating button 4 may be wireless to allow the user (e.g. surgeon) to ambulate safely without concern of getting the user's feet tangled in wires, losing balance, and consequently falling. Wireless actuators to electronic equipment are commonplace and well known to those skilled in the art of foot switches. The actuating button 4 may be located at the toe of the shoe 6 or the user's foot so as to allow the user to slightly flex the user's knee, plantar-flex the user's foot (i.e., point the user's toe) and apply gentle pressure on the actuating button in order to turn on the desired power tool or electronic instrument (e.g., electrocautery). This simple and efficient method to actuate an instrument will save the user much time and avoid the frustration that is caused by having to repeatedly locate a mobile foot switch.

It should be noted that although this specific embodiment of the disclosure describes the actuating button of the shoe pedal at the toe of the shoe, it is understood that depending on the user and specific application of the shoe pedal or foot switch 2, it may be more convenient or practical for the actuating button to be positioned at the heel, medial aspect, lateral aspect, dorsum, or plantar surface of the shoe. None of these positions change the intention of the shoe pedal (i.e., to make activation of a foot switch more convenient, more efficient, and more practical for the user).

The re-attachable shoe strap 8 may be made of one or more of a plurality of materials or fabrics such as cotton, nylon, leather, Naugahyde, neoprene, rubber, or any such material that is flexible. In this embodiment, the re-attachable strap 8 encircles the shoe to securely attach the actuating button 4 to the shoe 6 or foot. The strap may be attached to the shoe in a plurality of configurations (not necessarily encircling the circumference of the shoe). For example, the shoe strap may wrap over the vamp 7, the outsole 9, the heel 11, the quarter 13, the tongue 15, or the throat line 17, among other parts of the shoe 6. The varying materials or locations of attachment on the shoe 6 does not change the spirit of this invention. In some embodiments, the foot switch 2 may attach to the user's shoe via a disposable shoe cover. Or, there may be specially designed shoes that the Shoe Pedal attaches directly to the shoe, thus obviating the need for a reversibly re-attachable shoe strap.

To encircle the user's shoe 6, the first strap end 10 of the shoe strap 8 is attachable to the second strap end 12 with a re-attachable strap fastener 14. This re-attachable strap fastener 14 can be any attachment that temporarily joins the first and second strap ends. In some embodiments, a “hook and loop” fastener, such as the well-known Velcro® type of fastener is utilized. A clip, an adhesive, a buckle, magnets, screws, tines, nails, bolts, or a button (among others) are all considered suitable re-attachable strap fasteners, to the hook and loop type fastener.

In some embodiments, the re-attachable shoe strap 8 is used with a buckle 16 to attach the shoe strap 8 to the user's shoe 6. The buckle 16 attaches to the first strap end 10 via a permanent sewn attachment. Then, the second strap end 12 threads through the buckle 16 and back over the second strap end 12 and then attach reversibly on the second strap end via the strap fastener 14 (e.g., via Velcro®). The purpose of this buckle loop method is to allow the user to securely tighten the shoe strap 8 onto the shoe 6. The buckle 16 may be eliminated in some embodiments if the user finds that the first strap end 10 and the second strap end 12 can be securely attached to the user's shoe 6 using only the re-attachable strap fastener 14 (e.g., via hook and loop fastener such as Velcro®).

As shown in FIG. 2, the Velcro® re-attachable strap fastener 14 may be a two-part fastening device, with a strap hook pad 20 and a strap loop pad 22. The strap hook pad 20 and the strap loop pad 22 may be placed in series along the length of the shoe strap 8. The length of the shoe strap may be a Velcro® hook compatible fabric such as a flexible, typically non-woven, looped polyester material. By employing the looped, Velcro® hook compatible fabric, the separate strap loop pad can be eliminated, essentially incorporated into the shoe strap, to form the re-attachable strap fastener. Also, in FIG. 2 is shown the wireless actuating button 4 and the buckle 16 whose functions are described earlier in the disclosure.

While the present invention has been shown and described with reference to the foregoing embodiments, it is to be understood by those skilled in the art that other changes in form and detail may be made therein without departing from the spirit and scope of the invention. While the present invention may be embodied in different forms, the specification illustrates some embodiments of the invention with the understanding that the present disclosure is to be considered an exemplification of the principles of the invention, and the disclosure is not intended to limit the invention to the particular embodiments described.

In an alternate embodiment of the present invention, the device may have a rapidly attachable and detachable actuating button 4 that can be attached/detached from the shoe strap 8. This would allow the user to apply the shoe strap 8 to the shoe 6 once at the beginning of the day while reversibly remove and re-attach the actuating button from the shoe for each case quickly and with minimal effort. Or, a facility may provide each user their own shoe strap to keep on permanently with the understanding that the user will more easily attach the actuating button 4 at the beginning of the operation and detach it at the end of the operation. This might be easier than repeatedly attaching and detaching a secure shoe strap 8 for every operation.

In some embodiments of the invention, the actuating button may be reversibly attached to the shoe strap using Velcro, magnets, adhesives, a screw on mechanism, suction cup, vacuum-generating mechanism, or the like. On the back of the actuating button, any of these mechanisms of attachment could assist in the temporary attachment of the actuating button to the shoe strap. It is also conceived that a docking station will assist in the removal and re-attachment of the shoe pedal to facilitate the efficient and near effortless donning and doffing of the Shoe Pedal. Such a docking station would obviate the user's need to crouch down, sit down, or use the user's hands during the process of putting the device on or off. Such a docking station is meant purely for convenience to the user.

Another embodiment might be that the actuator button remains permanently attached to the user's shoe and automatically syncs with pre-programmed devices. In this situation, the user (e.g., a surgeon) may keep the actuator button always on the surgical footwear and the actuator button would automatically sync to a particular device that the surgeon commonly uses (e.g., bipolar electrocautery generator). Or, the user may prefer flexibility and would enter a personalized code into the user's choice of device that the user would like to sync with for a particular operation.

In some embodiments, a wireless power switch may have an actuating button, and means for attaching the actuating button to a user's foot and positioning the actuating button at at least one of a distal portion or a proximal portion of the user's foot. The means for attaching the actuating button may include a shoe having the actuating button integrally attached thereto, a strap, a foot cover, and/or a sock.

In some embodiments, a wireless power switch 2 has an actuating button 4, and an attachment mechanism 8 configured to removably attach the actuating button 4 to a user's foot. The attachment mechanism 4 may have at least one of (a) a strap 8 configured to removably attach the actuating button 4 to at least one of the user's foot or a shoe 6, (b) a shoe 6 having a receiving mechanism for receiving the actuating button, or (c) a shoe 6 having the actuating button integrally attached thereto.

The switch 4 may include a housing and circuitry for effectuating a control signal for operating a power device.

The receiving mechanism may include an interference fit between the shoe and the actuating button.

The receiving mechanism may include an interlock between the shoe and the actuating button.

The receiving mechanism may include a threaded interface between the shoe and the actuating button, a hook and loop fastener, a threaded fastener, a buckle, a clamp, or any suitable means for removably attaching the actuating button to the surgeon's shoe.

The actuating button may be shaped and configured to limit unintentional actuation of the actuating button. For example, the actuating button may include a housing that prevents actuation in the course of regular movement of the surgeon's foot through walking or standing, but allows actuation if the surgeon's foot moves beyond a preselected angle relative to the floor or another surface used to actuate the actuating button. In some embodiments, the housing may include a cup or other protective feature encasing a lower portion of the circuitry and/or actuator.

A method of making a wireless power switch may include providing an actuating button; and at least one of (a) providing an attachment mechanism configured to removably attach the actuating button to a user's foot, the attachment mechanism having a strap configured to removably attach the actuating button to at least one of the user's foot or a shoe, and coupling the actuating button to the attachment mechanism; (b) providing an attachment mechanism configured to removably attach the actuating button to a user's foot, the attachment mechanism having a shoe having a receiving mechanism for receiving the actuating button, and removably coupling the actuating button to the attachment mechanism; or (c) providing a shoe having the actuating button integrally attached thereto.

The method may include providing or using a device as previously illustrated and described herein.

A method of using a wireless power switch may include removably attaching the wireless power switch to a user's foot. The method may include providing or using a device as previously illustrated and described herein.

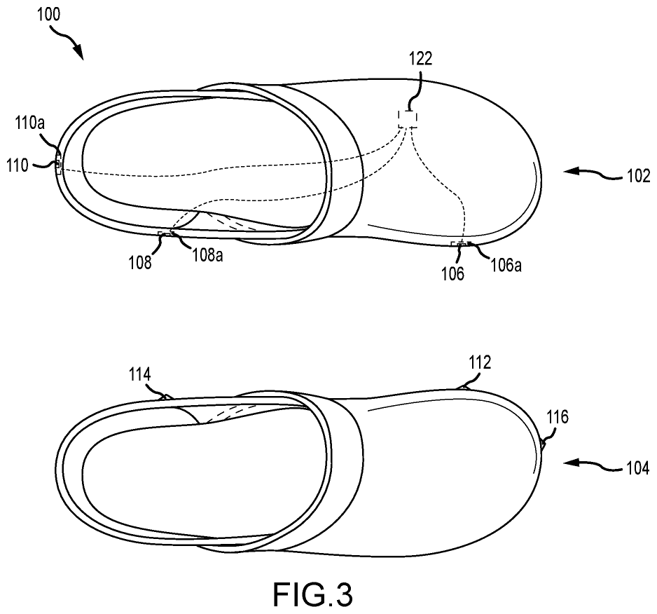

Turning now to FIG. 3, a foot switch system 100 is now described. The system 100 may include a first shoe 102 configured to be worn by a user's first foot. As illustrated the first shoe 102 is configured to be worn by the left foot, though the right foot is considered. The first shoe 102 may have a power switch 122 having one or more actuating buttons 106, 108, 110. The actuating button(s) 106, 108, 110 may be recessed relative to a housing(s) 106a, 108a, 110a so as to prevent inadvertent actuation during normal use and movement. The buttons 106, 108, 110 may be electrically coupled to a control mechanism 122 having a wireless communication mechanism.

The system 100 may include a second shoe 104 configured to be worn by the user's second foot.

As previously described herein, the actuating button(s) 106, 108, 110 may be removably attached to the first shoe 102. A means for attaching the actuating button(s) 106, 108, 110 may include a strap, a threaded engagement, a snap-fit engagement, an interference engagement, or a slip-on cover, for removably attaching the actuating button to the first shoe.

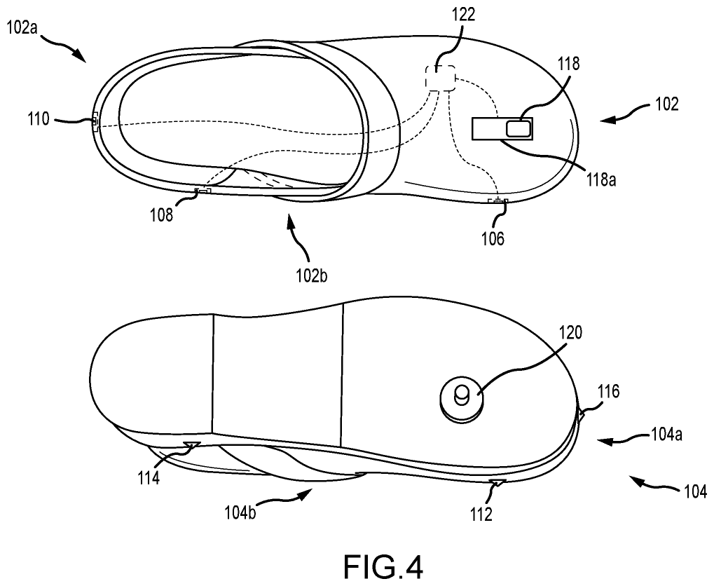

With simultaneous reference to FIG. 3 and FIG. 4, in some embodiments, the communication mechanism 122 may be configured to emit a variable wireless signal in response to an operation on an actuating button 118. The operation may include a variable input operation. For example, the user may cause a protrusion 120 to engage a button 118 to slide the button 118 relative to the housing 118a to ramp power to a powered device up or down. The actuating button 118 may be recessed relative to a housing 118a. The protrusion 120 may be retractable or elastic so as to allow the user to walk in the shoe 104 comfortably.

Continuing with FIG. 4, in some embodiments, an actuating button 110 positioned adjacent a heel portion 102a of the first shoe 102 and a protrusion 116 is positioned adjacent a toe portion 104a of the second shoe. The protrusion 116 may be configured to engage the actuating button 110.

In some embodiments, an actuating button 106, 108 is positioned adjacent an inner portion 102b of the first shoe 102 and a protrusion 112, 114 is positioned adjacent an inner portion 104b of the second shoe 104. A first protrusion 112 may be configured to engage a first actuating button 106. A second protrusion 114 may be configured to engage a second actuating button 108.

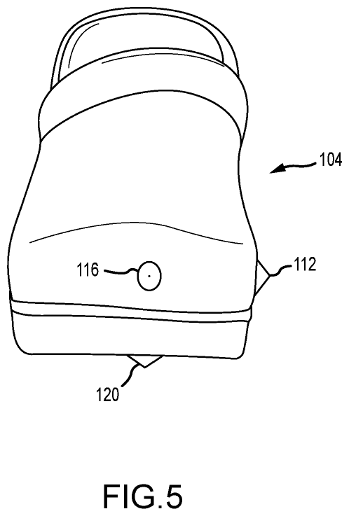

In some embodiments, an actuating button 118 is positioned adjacent an upper portion of the first shoe 102 and a protrusion 120 is positioned adjacent a lower portion of the second shoe 104, as most clearly seen in FIG. 5.

In some embodiments, the communication mechanism is configured to control a power output of a medical device.

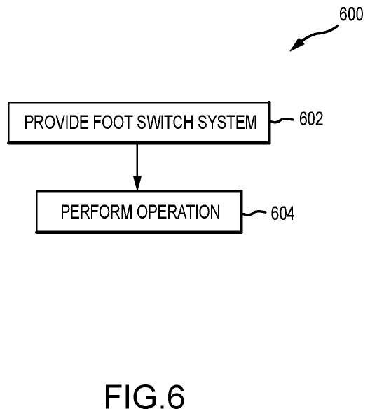

Turning now to FIG. 6, a method 600 is now described. The method 600 may include providing 602 a foot switch system, the foot switch system having a first shoe configured to be worn by a user's first foot, and a second shoe configure to be worn by the user's second foot, wherein the first shoe has a power switch having an actuating button and a communication mechanism. The method 600 may include performing 604 an operation on the actuating button to cause the communication mechanism to emit a wireless signal in response to the operation on the actuating button.

The method may include removably attaching the actuating button to the first shoe.

The method may be executing using embodiments of the foot switch and/or foot switch system described herein.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this disclosure is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of an actuator should be understood to encompass disclosure of the act of actuating—whether explicitly discussed or not—and, conversely, were there only disclosure of the act of activating, such a disclosure should be understood to encompass disclosure of an activating mechanism. Such changes and alternative terms are to be understood to be explicitly included in the description.

The previous description of the disclosed embodiments and examples is provided to enable any person skilled in the art to make or use the present invention as defined by the claims. Thus, the present disclosure is not intended to be limited to the examples disclosed herein. Various modifications to these embodiments may be readily apparent to those skilled in the art, and the generic principles defined herein may be applied to other embodiments without departing from the scope of the invention as claimed.

I claim:

1. A foot switch system comprising:
a first shoe configured to be worn by a user's first foot; and
a second shoe configured to be worn by the user's second foot; wherein
the first shoe has a power switch having an actuating button and a communication mechanism responsive to an operation on the actuating button, the communication mechanism configured to emit a wireless signal in response to the operation on the actuating button.

2. The foot switch system of claim 1, wherein:
the actuating button is removably attached to the first shoe.

3. The foot switch system of claim 2, wherein:
the actuating button is housed in a housing; and
the actuating button is recessed relative to an exterior surface of the housing.

4. The foot switch system of claim 2, further comprising:
at least one of a strap, a threaded engagement, a snap-fit engagement, an interference engagement, or a slip-on cover, for removably attaching the actuating button to the first shoe.

5. The foot switch system of claim 1, wherein:
the actuating button is housed in a housing; and
the actuating button is recessed relative to an exterior surface of the housing.

6. The foot switch system of claim 5, wherein:
the communication mechanism is configured to emit a variable wireless signal in response to the operation on the actuating button; and
the operation comprises a variable input operation.

7. The foot switch system of claim 5, wherein:
the second shoe has a protrusion configured to engage the actuating button to perform the operation.

8. The foot switch of claim 7, wherein:
the actuating button is positioned adjacent a heel portion of the first shoe and the protrusion is positioned adjacent a toe portion of the second shoe.

9. The foot switch of claim 7, wherein:
the actuating button is positioned adjacent an inner portion of the first shoe and the protrusion is positioned adjacent an inner portion of the second shoe.

10. The foot switch of claim 7, wherein:
the actuating button is positioned adjacent an upper portion of the first shoe and the protrusion is positioned adjacent a lower portion of the second shoe.

11. The foot switch of claim 10, wherein:
the protrusion is configured to selectively retract relative to the lower portion of the second shoe.

12. The foot switch of claim 1, wherein:
the communication mechanism is configured to control a power output of a medical device.

13. A method comprising:
providing a foot switch system, the foot switch system having a first shoe configured to be worn by a user's first foot, and a second shoe configured to be worn by the user's second foot, wherein the first shoe has a power switch having an actuating button and a communication mechanism; and
performing an operation on the actuating button to cause the communication mechanism to emit a wireless signal in response to the operation on the actuating button.

14. The method of claim 13, further comprising:
removably attaching the actuating button to the first shoe.

15. The method of claim 13, wherein:
the actuating button is housed in a housing; and
the actuating button is recessed relative to an exterior surface of the housing.

16. The method of claim 14, further comprising:
at least one of buckling a strap, threading the actuating button to the first shoe, snapping the actuating button to the first shoe, pressing the actuating button to the first shoe, or slipping on a shoe cover to removable attach the actuating button to the first shoe.

17. The method of claim 13, wherein:
the actuating button is housed in a housing; and
the actuating button is recessed relative to an exterior surface of the housing.

18. The method of claim 13, further comprising:
applying a variable input operation to the actuating button to emit a variable wireless signal.

19. The method of claim 13, further comprising:
causing a protrusion on the second shoe to engage the actuating button to perform the operation.

20. The method of claim 13, wherein:
the actuating button is positioned adjacent a heel portion of the first shoe and the protrusion is positioned adjacent a toe portion of the second shoe;
the actuating button is positioned adjacent an inner portion of the first shoe and the protrusion is positioned adjacent an inner portion of the second shoe; or
the actuating button is positioned adjacent an upper portion of the first shoe and the protrusion is positioned adjacent a lower portion of the second shoe.
